(19) United States
(12) Patent Application Publication
(10) Pub. No.: US 2013/0056455 A1
(43) Pub. Date: Mar. 7, 2013

(54) MEMBER, AND IN PARTICULAR, GRIPPING MEMBER, INTERIOR MEMBER, AND STEERING WHEEL

(71) Applicants: Kazushige Onishi, Shizuoka (JP); Koji Sugiyama, Shizuoka (JP); Mikio Ochiai, Shizuoka (JP); Hiromitsu Harada, Shizuoka (JP); Nobutaka Uematsu, Shizuoka (JP); Masato Unno, Shizuoka (JP); Minoru Oda, Shizuoka (JP)

(72) Inventors: Kazushige Onishi, Shizuoka (JP); Koji Sugiyama, Shizuoka (JP); Mikio Ochiai, Shizuoka (JP); Hiromitsu Harada, Shizuoka (JP); Nobutaka Uematsu, Shizuoka (JP); Masato Unno, Shizuoka (JP); Minoru Oda, Shizuoka (JP)

(73) Assignee: NIHON PLAST CO., LTD., Fujinomiya-shi (JP)

(21) Appl. No.: 13/603,207

(22) Filed: Sep. 4, 2012

(30) Foreign Application Priority Data
Sep. 5, 2011 (JP) 2011-192802

(51) Int. Cl. B60H 1/22; H05B 3/02

(52) U.S. Cl. 219/204; 219/530

(57) ABSTRACT

A member of the present invention is provided with: a base material 12 having a low thermal conductivity; a heating element 13 that is routed to a surface of the base material 12; and a covering material 11 having a high thermal conductivity, and covering the heating element 13 and the base material 12, in which the base material 12 includes a positioning portion 21 adapted to position the heating element 13, and the covering material 11 is formed so as to compensate each other in cooperation with the heating element 13, and closes at least a partial range in a region between an exterior face and the surface of the base material 12.

### CROSS REFERENCE TO RELATED APPLICATIONS

This application claims priority of Japanese Patent Application No. 2011-192802 filed on Sep. 5, 2011. The contents of this application are incorporated herein by reference in their entirety.

### BACKGROUND OF THE INVENTION

1. Field of the Invention

The present invention relates to a product that can be applied to a member including a gripping member or an interior member such as a manipulating handle or knob and a grip for manipulating a vehicle such as an automobile, an auto bicycle, a bicycle, or a motorboat, the product including a heating function.

2. Description of the Related Art

As gripping members or interior members of an automobile, thr example, there are exemplified a steering wheel, a shift knob, a door grip, an assist grip, a joystick manipulation knob, and an armrest or the like.

These gripping members are members that are touched and/or manipulated by a driver of an automobile, and in particular, in a cold region, a vehicle is parked outside for a long period of time, for example, whereby a surface temperature lowers, and if any of these members is touched, it is felt to be cold; and therefore, there is a need for improvement. As a countermeasure which should be taken, for example, a heater is incorporated in a grip portion of a steering wheel to thereby provide heating.

On the other hand, from the viewpoint of a need to take a global environment into an account, a vehicle (zero-emission vehicle ZEV) which does not generate a carbon dioxide with respect to cruising has been introduced into market. An electric vehicle (EN) cruising with the use of vehicle-mount storage battery, which is one aspect thereof entails a problem that if electric power is consumed in order to increase a temperature in room, an electric power available for use in cruising decreases, and as a result, a cruising distance also decreases.

In such a vehicle, warmness can be directly felt by a gripping member to be directly touched with hand, whereby even if heating is restrained, lowering of the driver's comfort can be prevented, and shortage of the cruising distance can also be restrained; and therefore, a use value of the gripping members, each of which is provided with a heating function, is considered to be high.

In order to efficiently heat a surface of a gripping manipulation portion, it is recommended that a heater be disposed on or near the surface to its required possible maximum level, and it is preferable to provide such a gripping member which is capable of appropriately transmitting a heat to the surface, and which does not lose a heat into a site other than the gripping manipulation portion.

As the related art, there exist: a heating-enable handle for automobile, which is provided with a covering member made of leather in particular, such as a sheet, a synthetic resin, or a texture product and an integrated heating insert that can be connected to an electric energy source, the heating-enable handle characterized in that the heating insert is formed by a warp-knitted fabric (refer to Japanese Unexamined Patent Application Publication No. 04-15162, for example); and a steering wheel having a grip portion, which is provided with a cored bar, a flexible netlike heater device that is positioned on an outer circumference of the cored bar, and a skin portion that integrally embeds and covers these cored bar and heater device (refer to Japanese Unexamined Patent Application Publication No. 11-268652, for example).

In the aforementioned Japanese. Unexamined Patent Application Publication No, 04-15162, there is disclosure of a handle that is capable of heating by covering a heating insert with a covering material made of leather or the like. For the heating insert, a warp-knitted fiber is used so that a contour of a heating element does not emerge on a surface.

However, there is a need to cover a handle surface with a covering material on which the heating insert is mounted in advance, and a thick heater wire constituting a net heater cannot be used in order to prevent impairment of an external view due to irregularities appearing on the covering material, and in addition, a terminal or the like adapted to supply electric power to the heater wire must be slimly and compactly designed so as not to degrade an external view of the covering material, and the heater device entails a difficult technical problem that remains unsolved.

Further, in the aforementioned Japanese Unexamined Patent Application Publication No. 11-268652, when a resin is injected and molded into a die, a net heater is placed in the die, and is integrally molded with the use of a spacer so as not to approach a cored bar at a predetermined distance or less.

By means of an integral skin foam body, a high density and a high thermal conductivity are obtained on a surface side, and on an internal side, foaming occurs and then a low density and a low thermal conductivity are obtained, enabling a heater to effectively function. However, it is difficult to restrain a distance from the surface to the heater, in other words, to a thermal transmission distance within a predetermined range, and it is not easy to heat a broad range uniformly.

### SUMMARY OF THE INVENTION

The present invention has been made in order to solve the conventional problem described above, and it is an object of the present invention to provide a member which is provided with an efficient heating function without a need for a covering material such as leather incorporating a heater, and which is easily improved in external view. In other words, the member of the present invention employed the features as described below.

(1) The member is provided with a base material having a low thermal conductivity, a heating element that is routed onto a surface of the base material, and a covering material having a high thermal conductivity, covering the heating element and the base material; the base material is provided with a positioning portion adapted to position the heating element; and the covering material is formed complementary to the heating element, and closes in a gapless manner at least a partial range in a region between an exterior face and the surface of the base material.

(2) In the abovementioned member, the positioning portion retains a flexible portion of the heating element to be routed.

(3) In the abovementioned member of (1) and (2), the positioning portion is provided with at least one of a protrusion portion and a recessed portion, and is integrally formed with the base material at the time of die molding thereof.

(4) in the abovementioned member of (3), the positioning portion is formed in a die splitting portion in die molding of the base material.

(5) The covering material for the abovementioned member of any of (1) to (4) closes the base material together with shrinkage all over a sectional circumference.

(6) A steering wheel made by assembling the abovementioned member of any of (1) to (5) is provided with: a boss portion having a rotational center portion; a grip portion that is disposed at a rotational peripheral edge portion, and is gripped and manipulated; and a coupling portion adapted to couple the grip portion and the boss portion with each other.

As the base material portion, a resin member having a rubber elasticity (such as polyurethane (foamed or foam-free) or olefin-based elastomer), a hard resin (such as PP or ABS), a light foaming body (bead-foamed styrol (foamed styrol), or PEP (foamed polyethylene) or the like can be used. It is preferable to provide a material having a low thermal conductivity (foamed polyurethane, foamed styrol, or the like), since it can restrain a thermal transmission quantity for cored bar or vehicle body and can transmit a large amount of heat to a surface side.

In addition, as the heating element, for example, an appropriate wire such as a copper alloy wire (such as a copper and nickel alloy wire or a copper and tin alloy wire) or a nichrome wire can be used. As the covering material, a covering material having a high thermal conductivity, a foam-free polyurethane resin-based skin, a thermoplastic elastomer, or the like can be selected. Advantageously, a metal foil such as a copper and aluminum alloy may be inserted, or alternatively, a heating property may be improved with the flaked metal being added to thereby enhance a thermal conductivity.

As far as the covering material is concerned, according to a manufacturing method for inserting a base material portion mounting a heating element thereon into a die, and injecting and integrally molding a skin, a series of processing steps such as cutting out from a material skin, needle hole processing or sewing, and terminal processing are restrained in comparison with a case of manually sawing leather, and the covering material is more suitable for use in mass production.

The members according to the present invention, in particular, a gripping member, an interior member, and a steering wheel, have the features as described above, and therefore, these members each attain advantageous effects described below.

The members each are provided with: a base material having a low thermal conductivity; a heating element that is routed onto a surface of the base material; and a covering material having a high thermal conductivity, the covering material covering the heating element and the base material, wherein a positioning portion adapted to position the heating element is provided on the base material, and the covering material is formed so as to compensate each other in cooperation with the heating element, and closes in a gapless manner at least a partial range in a region between an exterior face and the surface of the base material. The heating element is positioned and placed on the base material, and the surface of the base material is covered with the covering material in a state in which the covering material closes in a gapless manner complimentary thereto; and therefore, as long as the heating element is simply positioned with respect to the base material, the heating element can be reliably positioned by means of the covering material, thus making it easy to mount the heating element, and making it possible to restrain manufacturing costs. The thermal conductivity of the base material is lowered, and the covering material with its high thermal conductivity closes the heating element in a gapless manner; and therefore, the covering material comes into contact with all over the sectional circumference of the heating element, making it possible to receive a thermal energy, and making it possible to improve a heating efficiency of the exterior face. Even if a somewhat thick heating element is used, or alternatively, even if a plurality of heating elements is used, the exposure of irregularities to the external face can be restrained.

The positioning portion is provided at least one of such an aspect as to retain a flexible portion of the heating element to be routed, a protrusion portion, and a recessed portion, and it is possible to facilitate positioning of the heating element and to prevent displacement of the heating element until it has been closed by the covering material by employing an aspect of integral forming at the time of die molding of the base material or an aspect of forming at a die splitting potion in die molding of the base material.

As far as the covering material is concerned, if an attempt is made to close the base material together with a shrink all over the sectional circumference, the base material is integrally covered so as to be tightened by means of the covering material, an interfacial junction strength of the base material and the cover material can be obtained, and the heating element can be reliably retained against an external force exerted by a gripping manipulation or the like.

The steering wheel is formed in a comparatively large shape, and is gripped at the time of cruising a vehicle or the like; and therefore, this member is important in that a driver is easily prone to have an unnatural feeling of a touch or visual sense.

The present invention can be utilized as a very effective means for solving a problem in such use.

### BRIEF DESCRIPTION OF THE DRAWINGS

FIG. 1 is a front view of a steering wheel that is provided with a heating function of one embodiment of the present invention;

FIG. 2 is an enlarged perspective view of a site that is provided with the heating function of the steering wheel of FIG. 1;

FIG. 3 is a sectional view taken along the line A-A of FIG. 1;

FIG. 4 is an enlarged perspective view showing a mount site of a heater wire of a base material portion in FIG. 1;

FIG. 5 shows how to provide a cutout groove for a steering wheel by means of a cutter according to a second embodiment of the present invention, and is a schematic side view of the steering wheel;

FIG. 6 is a schematic perspective view of FIG. 5;

FIG. 7 is a schematic side view showing a state in which a heater wire is pressed into a base material portion in the second embodiment of the present invention;

FIG. 8 shows a third embodiment of the present invention, and is an explanatory exploded view of essential parts showing an example in which a base material portion using a foamed resin block is employed in place of a polyurethane-based base material portion in a steering wheel;

FIG. 9 shows an example of a device adapted to automatically mount a heater wire on a base material portion, wherein FIG. 9 (a) is an explanatory view showing a state before the heater wire is mounted, and FIG. 9 (b) is a schematic cross section showing a state of a base material portion after the heater wire has been mounted;

FIG. 10 shows an embodiment of another member incorporating a heating function of the present invention, wherein FIG. 10 (a) is a schematic perspective view of a speed change knob, FIG. 10 (b) is a schematic perspective view of a grab rail, and FIG. 10 (c) is a schematic perspective view of an armrest;

FIG. 11 is an enlarged sectional perspective view of essential parts showing an example in which a base material using an insert molding body of a foamed resin is employed in place of a polyurethane-based base material portion in a steering wheel of the present invention; and

FIG. 12 is an enlarged explanatory view of a surface portion of FIG. 11.

### DESCRIPTION OF THE PREFERRED EMBODIMENTS

The present invention is directed to a member that is provided with: a base material having a low thermal conductivity, a heating element that is routed onto a surface of the base material; and a covering material having a thermal conductivity, the covering material covering the heating element and the base material, wherein the base material is provided with a positioning portion adapted to position the heating element, and the covering material is a member that is formed so as to compensate each other in cooperation with the heating element, and closes in gapless manner an at least partial range of a region between an exterior face and the surface of the base material.

### First Embodiment

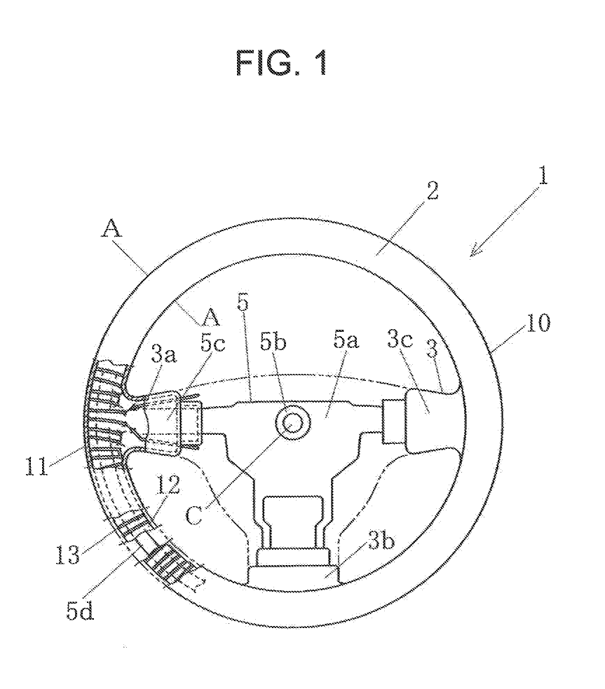

FIG. 1 is a front view of a steering wheel 1 that is provided with a heating function and is one embodiment of the present invention. The steering wheel 1 is schematically made of: a rim portion 2 formed in a circular ring shape, which is also referred to as a gripping manipulation portion, a grip portion, or the like; a spoke portion 3 (3a, 3b, 3c) that extends to a center C from three sites of an inner circumferential portion of the rim portion 2; and a boss portion 4 that is coupled with the rim portion 2 via the spoke portion 3, the boss portion including a boss plate 5a at its center having a boss 5b for coupling a rotary shaft (not shown) on a vehicle body side.

In the boss portion 4, an airbag module (not shown) is mounted on an opposite side to a driver's side, and a resin-based back cover (not shown) is mounted to a vehicle body side that is a rear of the opposite side.

A steering wheel main body 10 is schematically made of: a thin skin-shaped skin portion 11 made of a polyurethane, which is a covering material imparted by a leather texture formed in a microscopic irregular shape simulating leather on surface; a base material portion 12 that is a base material made of a foamed polyurethane, which is entirely covered with the skin portion 11; a cored bar 5 as a structure inside of the base material 12, the structure supporting the steering wheel main body 10 inside thereof; and a heater wire 13 that is routed in a rectangular wavelike shape on a surface of the base material portion 12.

The cored bar 5 includes a boss plate 5a, a spoke cored bar portion 5c, and a rim cored bar portion 5d; is obtained as a structure of the entirety of the steering wheel main body 10; and is molded in the shown shape by means of a method or the like for ejecting and casting a magnesium alloy or an alloy of a light metal such as duralumin, for example, in mold.

In the method for molding the base material portion 12, a foamed polyurethane utilized as a skin material for a steering wheel is adjusted so as to be highly foamed, and the adjusted foamed polyurethane is injected into an injection reaction molding die (RIM die) with the cored bar 5 being inserted. In other words, immediately before being injected into the RIM die, the foamed polyurethane is mixed with isocyanate and polyol, an additive agent such as a coloring agent or a foaming agent added to either one of isocyanate and polyol, and appropriately, an additive agent such as a stabilizer, a catalyst, or an ultraviolet absorbing agent and then the mixture is reacted to be polymerized in die to thereby form a foamed polyurethane. A Teflon (registered trademark) coating is applied to a product portion (cavity) of the RIM die so as not to frequently use a mold release agent for facilitating mold releasing of a molded article or so as not to use it at all. A shrinkage rate of a foamed polyurethane can be adjusted by means of polyol, isocyanate or a variety of additives to be selected, and is 1% to 2% in this example. It is preferable that the foamed polyurethane used for the base material portion 12 be stabilized in dimensions within a short period of time, and the one that exhibits a shrink of 80% to 90% within 24 hours after molded is selected.

In other words, a selected material is the one that exhibits a change of 90%, that is, the one that exhibits a shrinkage rate of 1.8% within the first 24 hours after molded as long as shrinkage advances with an elapse of time and finally a shrinkage rate of 2% is achieved, and thereafter, the shrinkage is completed within several days. A material that shrinks within a comparatively short period of time, and moreover, does not have a high shrinkage rate, is easily coupled with the skin portion 11, since its shape does not shrink inside of the skin portion 11 when the material is combined with the skin portion 11.

Next, a heater wire 13 which is a heating element is routed onto a surface of the base material portion 12 that is obtained as described above. The heater wire 13 is a single wire or a twisted wire with its wiring diameter of 2 mm or less with the use of a copper alloy wire, for example. A coating such as vinyl chloride or Teflon (registered trademark) resin is applied to a surface, and a surface oxidization prevention effect and an insulation property are obtained.

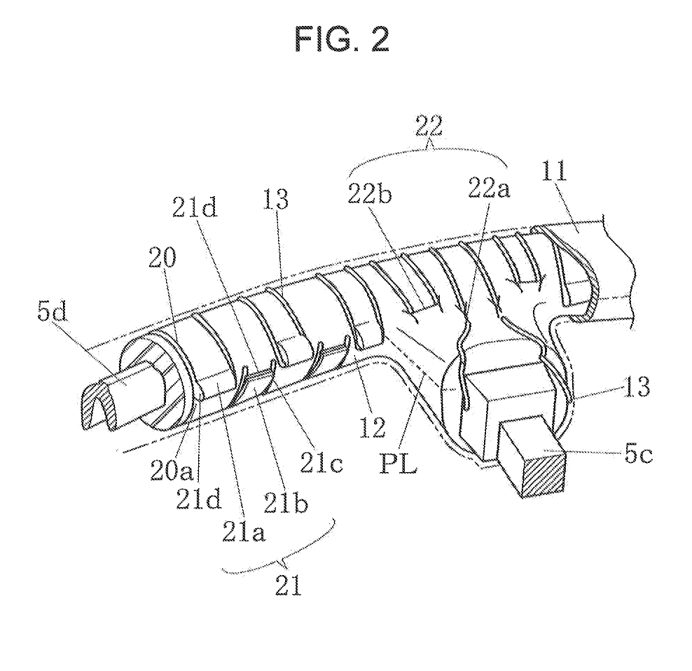

Fixation of the heater wire 13 is simplified to an extent such that the heater wire 13 is not displaced in the subsequent steps, and is preferable in respect of workability and product costs. Examples of structures of the base material portion 12 for fixing such a heater wire 13 will be described with reference to FIG. 2 to FIG. 4.

On the base material portion 12, substantially semicircular shaped grooves 20 in sectional view, which are an aspect of recessed portions, and protrusions 21 on the order of 2 millimeter in height, are provided. The protrusions 21 are intermittently provided along the inner and outer circumferential portions in a proximal portion (parting portion or die splitting portion) PL of a die splitting line of a die molding the base material portion 12. In other words, an upward protrusion 21a and a downward protrusion 21b are respectively protruded in a tilted manner to a first half die side and a second half die side so that an engagement face 21c is formed by an alignment face of the other half side. Grooves 20 are respectively engraved at both side parts of each of the protrusions 21a and 21b, and a terminal portion 20a is extended to the other half die side. The engagement face 21c forms an erected face 21d so as to shave off a curved face between the terminal portions 20a and 20a, the engagement face 21c increases in width, and when the engagement face 21c becomes wider and the heater wire 13 changes its orientation into a transverse direction, the heater wire is easily hooked on the engagement face 21c.

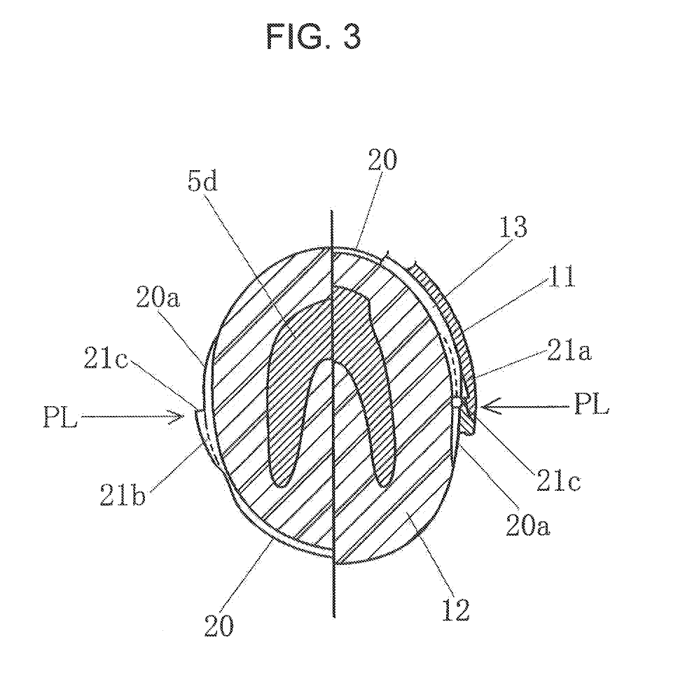

By means of such protrusions 21a and 21b, the heater wire 13 turns in a U shape and then is mounted on a surface of the base material portion 12 in a substantially rectangular zigzag shape (refer to FIG. 2 and FIG. 3). In addition, as far as the spoke portion 3 is concerned, a slit 22 is formed and then the heater wire 13 is mounted so as to be pressed-in. Both ends of the heater wire 13 are routed from the spoke portion 3a into the boss portion 4.

In this manner, a flexible portion of the heater wire 13 is retained and then mounted in a zigzag manner so as to reciprocate the surface of the base material portion 12 within the range of a short distance; and therefore, there is no need to employ a method of circulating a rim portion in one direction so as to be formed in a spiral shape, handling of which is facilitated as well in either of a case of: a manual work that is a work of receiving the heater wire 13 in a manufacturing process in a state in which the heater wire is wound around a drum of a large diameter and then supplying and mounting the heater wire on the steering wheel main body 10 via a feeding mechanism; and a case of use of an automatically driven mechanism.

Next, the base material portion 12 in a state in which the heater wire 13 is mounted on a surface is inserted into a skin portion molding die and then the skin portion 11 is integrally molded. As is the case with the base material portion 12, this molding is carried out in accordance with an RUM molding technique. Before molding, a coating is applied to a skin portion molding die in a state in which a die is opened before the base material portion 12 is placed in die. For coating, a mold releasing agent is first applied and then a barrier layer (coating film) is imparted. When the skin portion 11 is formed, a barrier transfers to the side of the skin portion 11 (in-mold coat technique) and then is sealed by means of an integrally molded protection film, and in the skin portion 11, its durability and abrasion proof property relative to ultraviolet rays are improved. Outside of the base material portion 12, a mixture solution reacting therewith to form polyurethane is injected, the formed polyurethane is superimposed and integrally molded outside of the base material portion 12, a so called over-molding is carried out, and then, the heater wire 13 is integrally embedded in a thickness range of the skin portion 11. The skin portion 11 is made of a foam-free polyurethane resin layer, which is also referred to as a solid urethane or a foam-free urethane. In addition to such a foam-free urethane, a so called lowly foamed polyurethane resin layer may be formed as a resin layer which is low in porosity due to foaming. The lowly foamed polyurethane in this case may be selected as the one whose specific gravity is on the order of 0.8.

The foamed polyurethane of the base material portion 12 is a so called sponge body, and is selected as the one whose specific gravity is 0.3 to 0.6. While thermal conductivity is low, the skin portion 11 is a foam-free body or a lowly foamed body as described above; and therefore, its thermal conductivity is superior to that of the base material portion 12 made of foamed polyurethane. Fine aluminum particles or the like may be added thereto, for example. Even if fine particles partially exist near a surface, no problem associated with external view will occur because of the presence of a barrier.

Polyurethane for forming the skin portion 11 may be selected as the one that has a large shrinkage rate after molded. Preferably, polyurethane is selected as the one having a shrinkage rate that is three times or more of the polyurethane used for the base material portion 12. In other words, when polyurethane having its shrinkage rate of 1% to 2% is used for the base material portion 12, the skin portion 11 having its shrinkage rate of the order of 6% is selected. The skin portion 11 is brought into intimate contact with the base material portion 12 by means of shrinkage. Use of a mold releasing agent is restrained at the time of molding of the base material portion, 12; and therefore, a releasing property of an interface between the skin portion 11 and the base material portion 12 is restrained.

In particular, as seen in the embodiment, the base material portion 12 is covered all over the sectional circumference; and therefore, a tightening force appropriately functions due to a shrink after molded and concurrently an interfacial bonding force is obtained. It is recommended that a shrinkage rate be on the order of five times of that of the base material portion 12, and if a shrinkage rate exceeds and becomes greater than the above shrinkage rate, the heater wire 13 is easily affected, and its external view may be not occasionally preferable.

The skin portion 11 integrally insertion-molds the heater wire 13, and in the skin portion 11, the heater wire 13 is embedded and sealed, that is, is closed. Therefore, a polyurethane constituting the skin portion 11 enters a full surface of the heater wire 13, and except in an exceptional case such as a case where fine air bubbles or the like are involved at the time of molding, packaging is carried out by means of the polyurethane in a gapless manner, a heat is transferred by means of thermal conduction, and the surface of the skin portion 11 can be heated efficiently.

In this manner, a steering wheel with a heater device which is substantially identical in external view to a conventional polyurethane-based steering wheel, in other words, a polyurethane-based steering wheel 1 integrally embedding a heater wire 13 in a skin portion 11 is manufactured.

### Second Embodiment

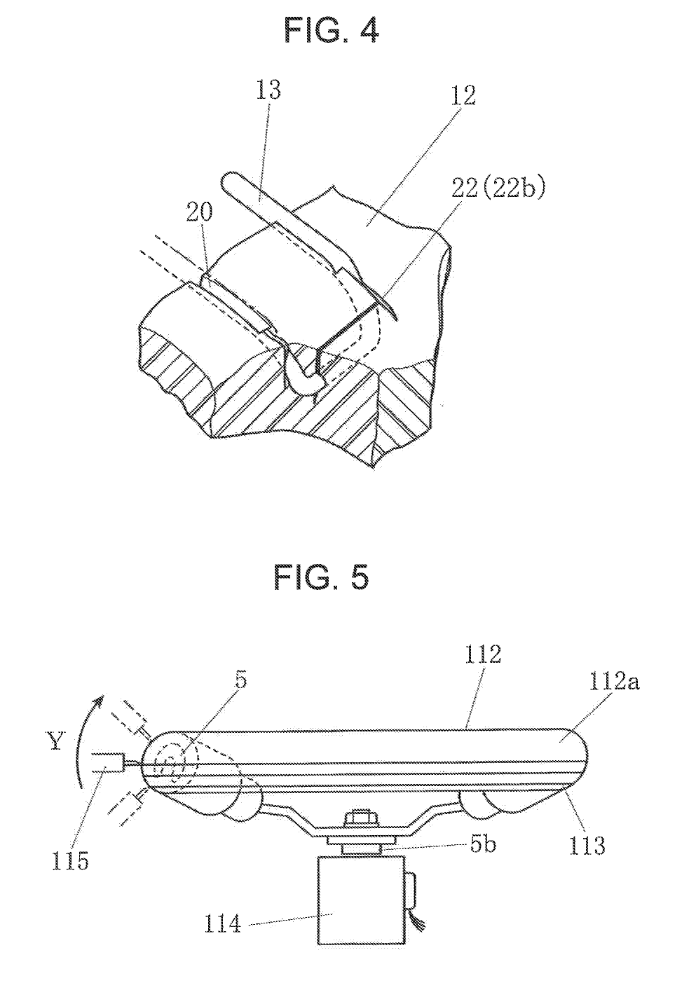

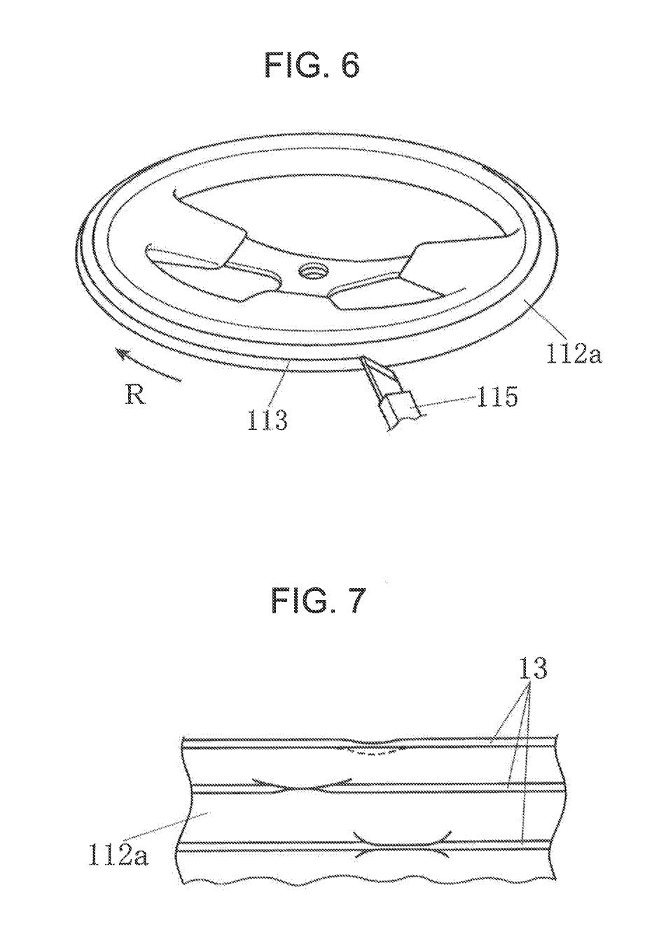

A flat base material portion 112 formed in a shape with no irregularities, which was employed in the first embodiment, was selected. In this base material portion 112, a cored bar 5 is placed in an RIM molding die; a polyurethane coving portion is formed around the cored bar 5, and after molding, a cutout groove 113 is formed in a circumferential direction with the use of a cutter knife. As shown in FIG. 5 and FIG. 6, a boss 5b is axially fixed to a rotating device 114 and then the axially fixed boss is rotated in the direction indicated by the arrow R of FIG. 6, a cutter 115 that is pressed against an outer circumferential face is moved along an outer circumferential face 112a as indicated by the arrow Y of FIG. 5, and a spiral cutout groove 113 is formed. In the cutout groove 113, as shown in FIG. 7, a heater wire 13 is pressed-in and then retained. As far as the heater wire 13 is concerned, both terminals are pulled out along a spoke 3 in accordance with the method shown in FIG. 1 and FIG. 4 or the like and then the pulled out terminals are connected to a power device that is provided with a current limitation mechanism for temperature control, although not shown.

### Third Embodiment

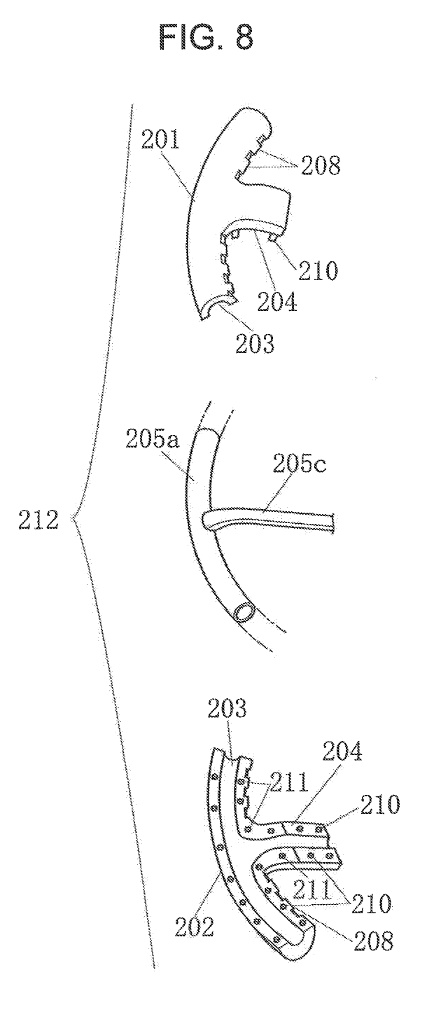

FIG. 8 shows an example of a base material portion 212 using a foamed resin block in place of the polyurethane-based base material portions 12 and 112 of the foregoing embodiments.

The foamed resin block is a high foamed molding body that is made of a foamed polyethylene, a foamed polystyrene or the like, for example, and that is formed by means of injection molding, beads foamed molding or the like. Protection film or primer processing is appropriately carried out to on a surface be suitable for a molding material for a skin 11 to be used, in such a manner as to prevent erosion exerted by a molding material and as to obtain an interfacial bonding strength. For example, by means of a reaction solution for polyurethane molding, a foamed polystyrene is dissolved and then a volume is reduced; and therefore, a coating film as a protection film is formed on a surface.

An iron pipe is subjected to coiling processing so as to form a circular ring-shaped rim cored bar 205a and then a spoke cored bar 205c to be connected to a boss plate, although not shown, is integrally bonded with the rim cored bar 205a by means of welding.

The foamed resin block is made of an upper shell 201 and a lower shell 202, and in the aspect of FIG. 8, a complete circumference of the rim cored bar 205a is divided into a plurality of parts to form a construction of four parts, for example, and further, a total of eight parts each having an upper shell and a lower shell are formed. Of course, a construction of a total of two parts of an upper shell and a lower shell covering all over the circumference may be formed. Each of the shells 201 and 202 has a groove portion 203, which houses the rim cored bar 205a and the spoke cored bar 205c, and an opposite face 204, and on the opposite face 204, a boss 210 and a circular hole 211 which are complimentary irregularities are formed. According to such a foamed resin block, the base material 212 is prepared for by assembling the parts ready for each item, not by means of RIM molding.

For each of the shells 201 and 202, a heater wire can be engaged by means of protrusions 208 that are intermittently provided on an inner circumferential portion. In place of such protrusions, a heater wire may be held by striking and positioning the heater wire in a foamed resin block so as to be routed through a gate portion of a gate-shaped staple which is available for business use or architectural use.

A base material portion 222 with the heater wire being routed onto a surface is covered with a foam-free polyurethane as is the case with the foregoing embodiments and then a steering wheel is manufactured.

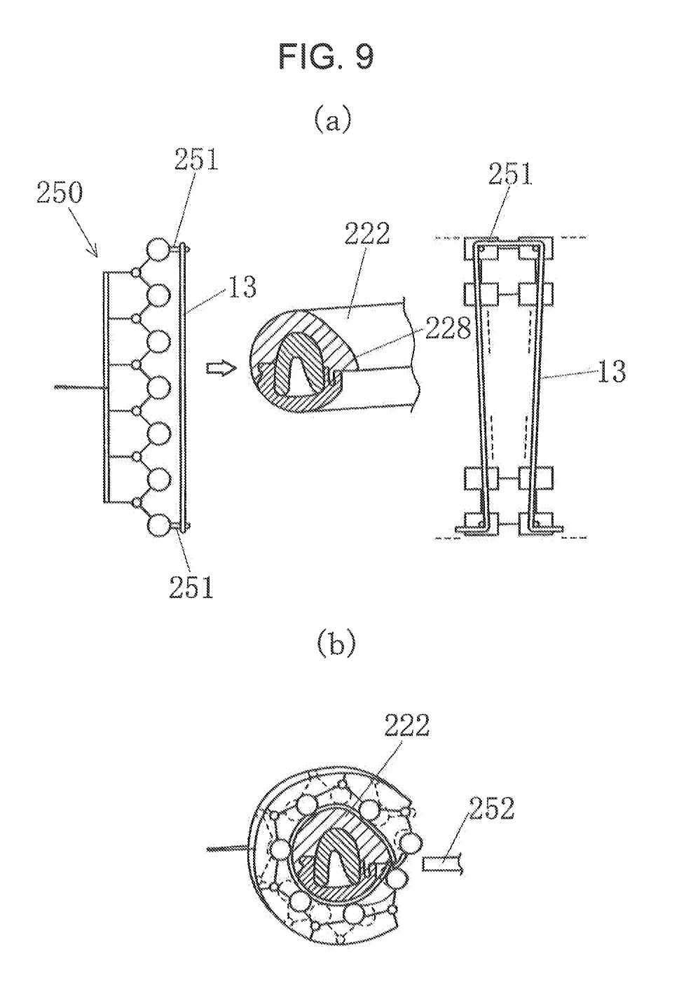

FIG. 9 shows an example of a device adapted to automatically mount a heater wire 13 on a base material portion 222. As shown in FIG. 9 (a), on an outer circumferential side of the base material portion 222, a mount jig 250 that is a multiple joints body supports the heater wire 13 that is held in a zigzag manner, by means of a pin 251 of a terminal.

The mount jig that is deformed along the base material portion 222 is wound around the base material 222, the heater wire 13 is pressed by means of the pin 252, the pressed heater wire is released from the pin 251 of a terminal, and then, the released heater wire is engaged with a protrusion 228.

It is to be noted that a skin portion ills formed by means of RIM molding of a foam-free polyurethane resin in any of the foregoing embodiments; and however, the present invention is not limited to this material and technique. For example, this skin portion may be formed by means of an injection molding technique of a thermoplastic elastomer resin, or alternatively, a resin may be formed in a thin skin shape by means of an injection die technique. In addition, a centrifugal force (rotational molding) may be utilized for the skin portion.

### Fourth Embodiment

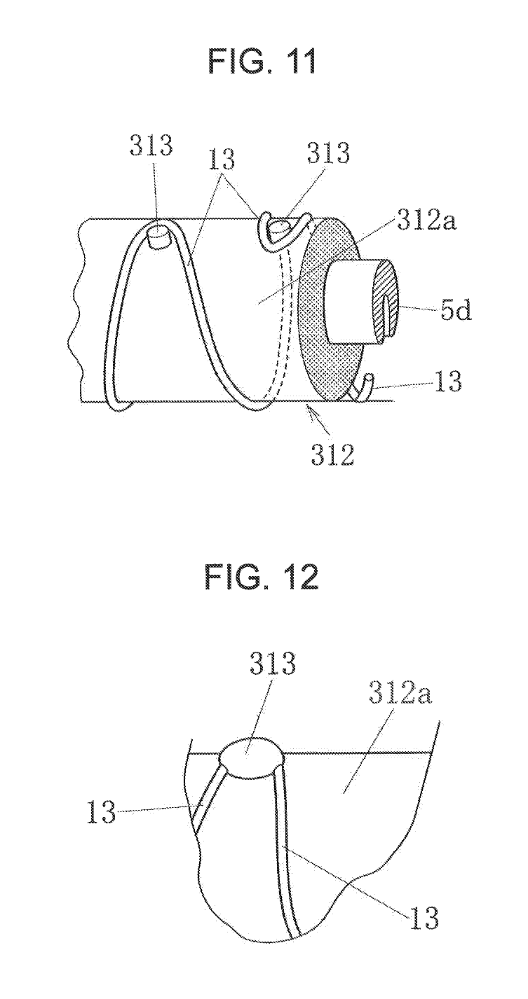

FIG. 11 shows an example of a base material portion 312 using an insert molding body of a foamed resin in place of the polyurethane-based base materials 12 and 112 of the foregoing embodiments.

The foamed resin is formed by adding a chemical foaming agent to a polypropylene resin, for example, and a cored bar is inserted into a molding die with the use of an inline screw-type injection molding mechanism to thereby form an integrally molded foamed resin base material covering a cored wire 5 (5d) therewith.

On a surface of the base material portion 312, a plurality of bosses 313 is disposed and formed so as to be spaced from each other at their predetermined intervals, and a heater wire 13 is mounted so as to be wound around the bosses 313.

Each boss 313 has a greater height than a diameter of the heater wire 13, and for example, when the diameter of the heater wire is 1 mm, the height of the boss 313 is set to 3 mm.

The heater wire 13 is retained so as to come into intimate contact with a surface 312a of the base material portion 312, the bosses 313 are welded by means of a thermal welder, an ultrasonic horn or the like, and as shown in FIG. 12, the welded bosses are rolled up into balls on a surface 312a so as to envelope the heater wire 13. When a foamed resin constituting the base material portion 312 is cooled and cured, the heater wire 13 is securely fixed along the surface 312a.

Primer or flame treatment as surface processing is applied to the base material portion 312 on which the heater wire 13 is thus mounted, and in a state in which surface activity of a polypropylene resin is enhanced, as is the case with the foregoing embodiments, insert RIM molding of the polyurethane resin is carried out, thereby making it possible to obtain a steering wheel to which a skin portion is imparted, the steering wheel being provided with a heater device therein.

In the above embodiment has been described using a cross-section of the circular heater wire as a heating element, but the cross section of the heater wire may be non-circular shaped. For example, the heating element may be formed on a short shaped and a ribbon shaped (a strip shaped). Further, the heating element may be a ribbon shaped (a strip shaped) resin base material which has a high thermal conductivity and has stored a plurality of heater wire having a circular cross-section.

### INDUSTRIAL APPLICABILITY

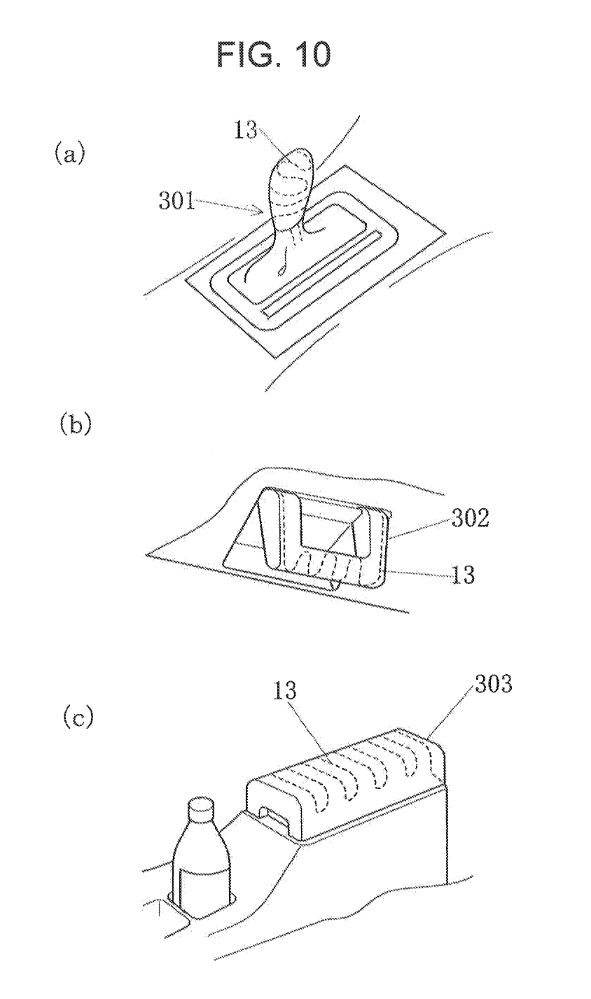

As gripping members and interior members which are members, in addition to a steering wheel, there are exemplified a speed change knob 301, a grab rail 302, an armrest (compatible with a console box lid) 303 or the like, shown in FIG. 10 (a) to FIG. 10 (c).

What is claimed is:

1. A member comprising:
a base material having a low thermal conductivity;
a heating element that is routed to a surface of the base material; and
a covering material having a high thermal conductivity, and covering the heating element and the base material, wherein:
the base material includes a positioning portion adapted to position the heating element; and
the covering material is formed so as to compensate each other in cooperation with the heating element, and closes at least a partial range of a region between an exterior face and the surface of the base material.

2. The member according to claim 1, wherein the positioning portion retains a flexible portion of the heating element to be routed.

3. The member according to claim 1, wherein
the positioning portion includes at least one of a protrusion portion and a recessed portion, and is integrally formed at a time of die molding of the base material.

4. The member according to claim 3, wherein the positioning portion is formed in a die splitting portion in die molding of the base material.

5. The member according to claim 1, wherein
the covering material closes the base material together with shrinkage all over a sectional circumference.

6. A steering wheel comprising:
a boss portion having a rotational center portion;
a grip portion that is disposed at a rotational circumferential edge portion, and that is gripped and manipulated; and
a coupling portion adapted to couple the grip portion and the boss portion with each other,
wherein the member according to claim 1 is incorporated in the grip portion.
